(19) United States
(12) Patent Application Publication
(10) Pub. No.: US 2008/0033817 A1
(43) Pub. Date: Feb. 7, 2008

(54) Mobile device assuming role of identity card

(75) Inventors: Kristopher C. Billmaier, Kirkland, WA (US); James A. Billmaier, Woodinville, WA (US); David P. Billmaier, Woodinville, WA (US); John M. Kellum, Woodinville, WA (US)

Correspondence Address: FSP LLC, P.O. BOX 890, VANCOUVER, WA, 98666, US

(73) Assignee: Patent Navigation Inc., Woodinville, WA (US)

(21) Appl. No.: 11/811,266

(22) Filed: Jun. 8, 2007

Related U.S. Application Data
(60) Provisional application No. 60/812,359, filed on Jun. 8, 2006.

(51) Int. Cl. G06Q 30/00

(52) U.S. Cl. 705/14

(57) ABSTRACT

A method includes identifying co-location with an organization, and a mobile device assuming a role of an affinity and/or loyalty card associated with the organization. The mobile device interacts with co-located equipment of the organization to facilitate a transaction.

### PRIORITY CLAIM

The present application claims priority to United States provisional patent application MOBILE DEVICE ASSUMING ROLE OF IDENTITY CARD, having application No. 60/812,359, filed on Thursday, Jun. 8, 2006, which is incorporated herein by reference.

### TECHNICAL FIELD

The present disclosure relates to mobile devices and affinity/loyalty cards.

### BACKGROUND

Mobile shoppers frequently encounter transaction situations in which their loyalty/affiliation with an organization can result in cost savings and/or transaction facilitation. Present techniques for managing such affiliation are cumbersome and generally rely on manual location and presentation of affinity/loyalty cards.

### SUMMARY

The following summary is intended to highlight and introduce some aspects of the disclosed embodiments, but not to limit the scope of the claims. Thereafter, a detailed description of illustrated embodiments is presented, which will permit one skilled in the relevant art to make and use various embodiments.

A method may include and/or involve identifying co-location with an organization, a mobile device assuming a role of an affinity and/or loyalty card associated with the organization, and the mobile device interacting with co-located equipment of the organization to facilitate a transaction. The mobile device may include and/or involve one or more of a cell phone, personal digital assistant, camera, or other handheld device assuming the role, and/or a watch, ring, medallion, jewelry, or other worn item.

A location of the mobile device may be identified and associated with the organization. The organization may be selected from a list of organizations stored and displayed by a mobile device. One or more brand names associated with the organization may be identified. The mobile device may display at least a partial image of the card, and/or display a bar code for the card, and/or the mobile device may access one or more online databases in order to obtain information to assume the role of the mobile device.

The mobile device may interact with point-of-sale equipment, and/or with one or more bar code scanners. The mobile device may communicate user account information and/or stored value associated with the card.

Identifying a location of a mobile device may include and/or involve applying cellular wireless communication and/or GPS to identify the location of the mobile device, and/or apply short and/or medium range wireless technology to identify the location of the mobile device, and/or apply one or more photos and/or scanned images to identify the location.

Applying short and/or medium range wireless technology to identify the location of the mobile device may include and/or involve applying Wi-Fi and/or derivatives thereof, applying Bluetooth and/or derivatives thereof, applying Buzzby and/or derivatives thereof, applying RFID and/or derivatives thereof.

Other system/method/apparatus aspects are described in the text (e.g., detailed description and claims) and drawings forming the present application.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of an environment in which a mobile device may assume the role of a loyalty and/or affinity card.

FIG. 2 is a flow chart of an embodiment of a process of a mobile device assuming the role of a loyalty and/or affinity card.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

Environment in which a Mobile Device May Assume the Role of a Loyalty and/or Affinity Card

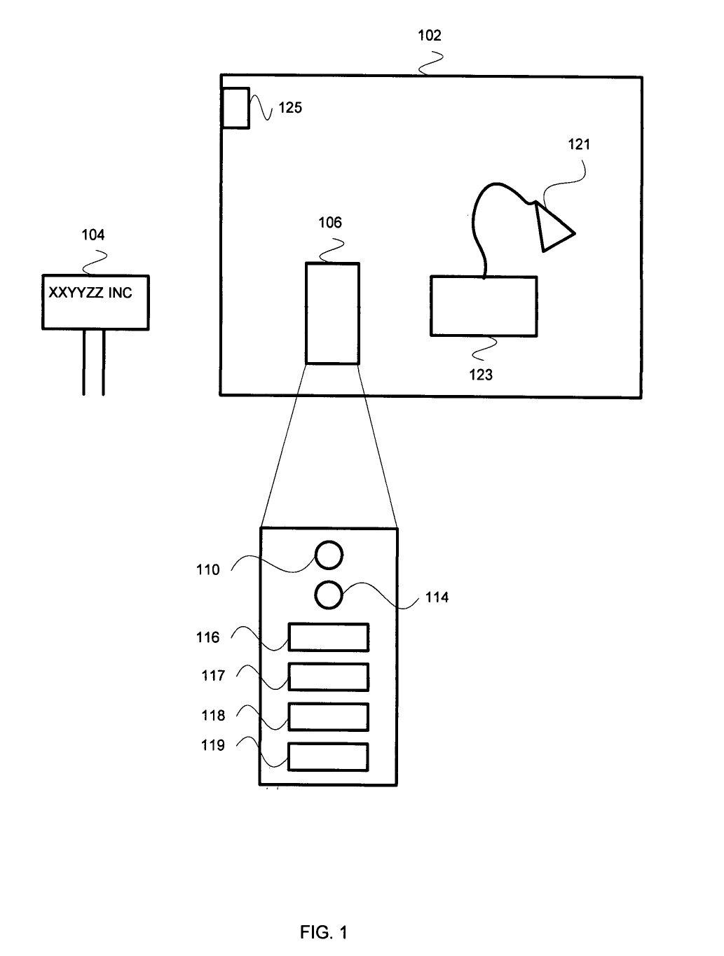

FIG. 1 is a block diagram of an embodiment of an environment in which a mobile device may assume the role of a loyalty and/or affinity card. A building, room, or some other area 102 contains various things. Herein, the building, room, or area 102 will be referred to as the building 102. In this illustration, the building comprises a business or organization location. The building has a sign 104 identifying it (XXYYZZ building or company).

Located within the building 102 there may be an item 125 from which information may be obtained by a mobile device 106. The mobile device 106 may be able to obtain information from the item or items 125 using its own capabilities. For example, the mobile device 106 may have the capability to capture an image of the item 125 and process the image to obtain information from the item or items 125. As a second example, the mobile device 106 and the item 125 may be able to communicate electronically to affect an information exchange.

The information exchanged may include identification of the business or organization or identification of some characteristic of the business or organization. For example, the mobile device 106 may communicate electronically with a device 125 within the building 102 to learn that the location is a retail location for a particular retail chain. Alternatively or additionally, the information obtained may include identification of a manufacturer associated with the item 125. For example, item 125 may be a sign announcing a store display of a particular manufacturer's goods. Either by image recognition or electronically, the mobile device 106 may be able to recognize the manufacturer.

In some embodiments, the mobile device 106 may use information obtained from something located near the building 102, such as the sign 104, to identify the business or organization or some characteristic of the business or organization.

In some embodiments, the mobile device 106 may use location information at least in part to obtain the identifying information about the organization or business. For example, the mobile device 106 may have Global Positioning System (GPS) capabilities that enable it to recognize a position. The mobile device 106 may have the capability to process GPS information either directly or by interacting with some network and/or device to associate a location with a business or organization.

In some embodiments, the mobile device 106 may automatically (meaning with a person not having to take an action to initiate the capability) perform the identification processing upon becoming near or co-located to the item 125 with which it may use to accomplish identification. For example, upon co-location, the mobile device 106 and the item 125 may communicate electronically using Bluetooth, Wi-Fi, RFID, or in some other short or medium range wireless manner. In some cases, a person may have to direct the mobile device 106 to initiate identification logic.

In some embodiments, a person may have to provide some of the identifying information for the business, organization, or manufacturer (herein referred to from this point on as the organization) to the mobile device 106. For example, the device 106 may present a list of candidate organizations to the person using some capability it has, such as a display 117 or speaker. The person may then select the organization. As a second example, the person may type text using a keypad or speak into a microphone of the device 106 to communicate the organization to the device 106. As a third example, a person may select a location on a map which may be presented on the display of the device 106. The particular physical and logical capabilities of the device 106 may determine how the identification of the co-located organization occurs.

The mobile device 106 may comprise various capabilities such as a camera 110 or other scanning or image capture means, a microphone 116, a display 117, a processor and memory 118, and a keypad or keyboard 119. Such capabilities may vary depending on the particular device and not all are illustrated. For example, the device 106 may have a speaker or wireless capabilities. By way of example, the mobile device 106 could be one or more of a cell phone, personal digital assistant, camera, or other handheld device. The mobile device 106 could be a watch, ring, medallion, jewelry, or other worn item.

The environment illustrated may comprise a device 123 which may have scanning capability 121. This device 123 may use its scanning capabilities 121 to obtain information from the mobile device 106. An example of such an device 123 would be a retail checkout (a.k.a. point of sale) scanner. Additionally, in some embodiments this device 123 may have wireless communication capabilities. For example, the device 123 may be able to use its communication capabilities to identify the organization. Also, the device 123 may, when it possesses communication capabilities, obtain information from the mobile device 106 in that manner in addition to or instead of by scanning.

Once co-location with an organization is identified, a mobile device 106 may assume the role of an affinity and/or loyalty card associated with the organization. The mobile device 106 may interact with co-located equipment 123 of the organization to facilitate a transaction. For example, the mobile device 106 may present either an image of a loyalty card on its display 117. Sometimes, only a portion of such an image may be displayed, for example, a barcode which may identify a particular loyalty card. (The barcode may be used by logic associated with the organization's equipment to link the card to a particular customer.). The scanner 123 and 121 may scan the displayed loyalty card or barcode.

Process of a Mobile Device Assuming the Role of a Loyalty and/or Affinity Card

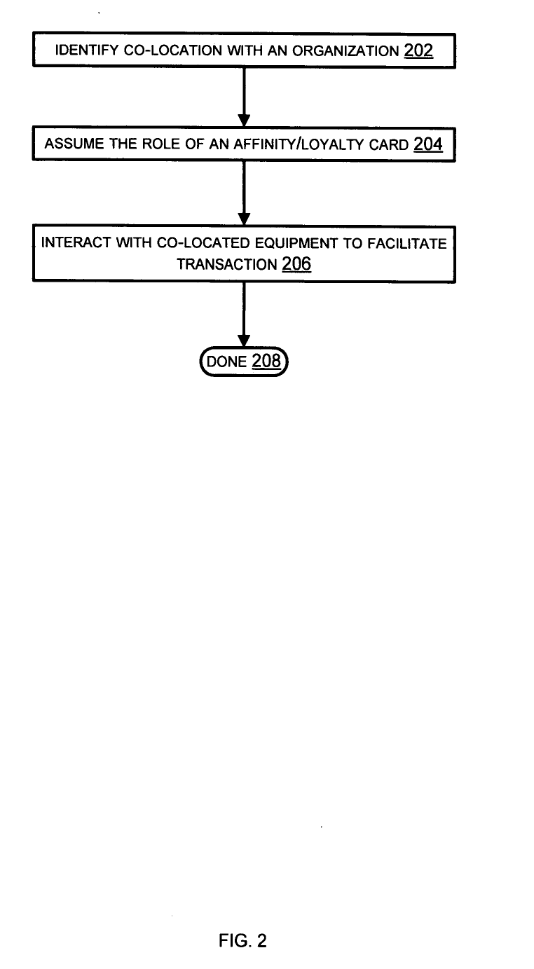

FIG. 2 is a flow chart of an embodiment of a process of a mobile device assuming the role of a loyalty and/or affinity card.

At 202, the mobile device 106 identifies the organization (business, organization, or manufacturer as described before). The identification may occur automatically. The identification may be performed by the device 106 after initiation by a person. Image capture, wireless communication, or location identification may be involved in the identification. The identification may be directed at least in part by a person. The person may select choices from a visual or spoken list. The person may identify a location on a presented map. The particular manner in which identification occurs will depend on the physical and logical capabilities of the particular device.

At 204, the device assumes the role of an affinity or loyalty card. Assuming this role may involve displaying the loyalty or affinity card or a portion thereof, such as its barcode. The device may assume this role without interacting with any other equipment. The device may, in some embodiments, interact with other equipment in order to obtain information prior to assuming the role of the affinity or loyalty card. For example, the device may communicate wireless with other equipment, possibly using the Internet, in order to complete the role assumption.

At 206, the device interacts with co-located equipment in order to facilitate a transaction. This interaction may include the scanning by the co-located equipment of a barcode which has been displayed on the device. This interaction may in some embodiments include wireless communication between the device and the co-located equipment.

Co-Location

Identifying co-location with an organization may include and/or involve identifying a location of a mobile device and associating the location of the mobile device with the organization. This may involve applying cellular wireless communication and/or GPS technology to identify the location of the mobile device, and/or applying short and/or medium range wireless technology to identify the location of the mobile device. Examples of applying short and/or medium range wireless technology to identify the location of the mobile device include applying Wi-Fi and/or derivatives thereof, applying Bluetooth and/or derivatives thereof, applying Buzzby and/or derivatives thereof, and/or applying RFID and/or derivatives thereof.

In some embodiments, identifying a location of a mobile device may involve applying one or more photos and/or scanned images to identify the location. For example, a particular retail chain may have its name, a logo, or a barcode which can be scanned when at the location. A candidate for image capture or scanning for identification purposes would be the store name as presented in a store sign, at a merchandise display, or on a store circular. In some embodiments, recognition of an organization may occur by matching image characteristics without text recognition. For example, the store name may have characteristics such as color, font, and contrast which can be used for recognition. A captured or scanned image may be compared to a previously captured or scanned image to affect recognition.

In other embodiments, identifying location may involve selecting the organization from a list of organizations stored and displayed by a mobile device. In some embodiments, identifying co-location with an organization may involve recognizing one or more brand names associated with the organization. For example, a mobile device within an organization such as a retail store may interact with an RFID tag on an item of clothing. The RFID obtained information may be used to identify that the clothing is an in-store brand for a particular retail chain.

Role Assumption and Interaction

Assuming a role of an affinity and/or loyalty card associated with the organization may include and/or involve the mobile device displaying at least a partial image of the card, and/or displaying a bar code for the card. The mobile device may access one or more online databases in order to obtain information to assume the role.

To facilitate a transaction, the mobile device may interact with point-of-sale equipment, such as one or more bar code scanners.

In some embodiments, the mobile device may communicate user account information and/or stored value associated with the card to and/or from co-located equipment of the organization. For example, the mobile device may present credit or debit card information to the point-of-sale equipment. The mobile device may contain stored value (as a pre-paid phone card does) which can be used in affecting the transaction.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A method comprising:
identifying co-location with an organization;
a mobile device assuming a role of an affinity and/or loyalty card associated with the organization; and
the mobile device interacting with co-located equipment of the organization to facilitate a transaction.

2. The method of claim 1, wherein the mobile device assuming a role of an affinity and/or loyalty card associated with the organization further comprises:
one or more of a cell phone, personal digital assistant, camera, or other handheld device assuming the role.

3. The method of claim 1, wherein the mobile device assuming a role of an affinity and/or loyalty card associated with the organization further comprises:
a watch, ring, medallion, jewelry, or other worn item assuming the role.

4. The method of claim 1, wherein the identifying co-location with an organization further comprises:
identifying a location of a mobile device and associating the location of the mobile device with the organization.

5. The method of claim 4, wherein the identifying a location of a mobile device further comprises:
applying cellular wireless communication and/or gps to identify the location of the mobile device.

6. The method of claim 4, wherein the identifying a location of a mobile device further comprises:
applying short and/or medium range wireless technology to identify the location of the mobile device.

7. The method of claim 6, wherein the applying short and/or medium range wireless technology to identify the location of the mobile device further comprises:
applying Wi-Fi and/or derivatives thereof, applying Bluetooth and/or derivatives thereof, applying Buzzby and/or derivatives thereof, applying RFID and/or derivatives thereof.

8. The method of claim 4, wherein the identifying a location of a mobile device further comprises:
applying one or more photos and/or scanned images to identify the location.

9. The method of claim 1, wherein the identifying co-location with an organization further comprises:
selecting the organization from a list of organizations stored and displayed by a mobile device.

10. The method of claim 1, wherein the identifying co-location with an organization further comprises:
recognizing one or more brand names associated with the organization.

11. The method of claim 1, wherein the mobile device assuming a role of an affinity and/or loyalty card associated with the organization further comprises:
the mobile device displaying at least a partial image of the card, and/or displaying a bar code for the card.

12. The method of claim 1, wherein the mobile device assuming a role of an affinity and/or loyalty card associated with the organization further comprises:
the mobile device accessing one or more online databases in order to obtain information to assume the role.

13. The method of claim 1, wherein the mobile device interacting with co-located equipment of the organization to facilitate a transaction further comprises:
the mobile device interacting with point-of-sale equipment.

14. The method of claim 1, wherein the mobile device interacting with co-located equipment of the organization to facilitate a transaction further comprises:
the mobile device interacting with one or more bar code scanners.

15. The method of claim 1, wherein the mobile device interacting with co-located equipment of the organization to facilitate a transaction further comprises:
the mobile device communicating user account information and/or stored value associated with the card.
